(19) United States
(12) Patent Application Publication
(10) Pub. No.: US 2011/0191697 A1
(43) Pub. Date: Aug. 4, 2011

(54) METHOD AND SYSTEM FOR DISCOVERY OF LOCAL ACTIVITIES BASED ON AUTONOMOUS SUGGESTION FOR DISCOVERY OF LOCAL ACTIVITIES

(76) Inventors: Victor Sumner, Waterloo (CA); Cameron Turner, Waterloo (CA); Robert M. Drimmie, Kitchener (CA); Jeffrey Sambells, Guelph (CA)

(21) Appl. No.: 12/699,394

(22) Filed: Feb. 3, 2010

(51) Int. Cl. G06F 15/16; G06F 3/048

(52) U.S. Cl. 715/758; 709/203

(57) ABSTRACT

A computer-implemented method and system for autonomously suggesting an activity to a user of a locality platform application, based on a range of locality factors. The method comprises accessing a locality platform application at the user interface of the client device, determining a location of the client device, computing at least one influencer factor based on the determined location, compiling at least one suggestion for the locality-related activity, the compiled suggestion at least partly based on the at least one influencer factor, and providing, at the user interface of the client device, the at least one suggestion.

### FIELD

The present invention relates to a method and computer system for autonomously suggesting an activity to a user of a locality platform application, based on a range of locality factors.

### BACKGROUND

The Internet and the World Wide Web continue to evolve rapidly with respect to both volume of information and number of users. The Internet is a collection of interconnected computer networks. The World Wide Web, or simply the Web, is one of the services built upon the Internet's infrastructure and is the dominant embodiment of the Internet for the lay person. The web contains a vast amount of information on many subjects, including local businesses, local events, local parks and recreation options as well as reviews, ratings and ranked lists for all of these kinds of data.

Typically a User is required to know the URL of the web site containing the desired data or employ the use of a search engine to uncover that URL prior to obtaining their desired information. A search engine is a tool that facilitates web navigation based upon entry of a search query comprising one or more keywords. Most search engines used for retrieval of electronic information are dependent on a user inputting a particular text string describing the requested content, and then processing the content to find material which relates to the search string. The relevance or desirability of the retrieved content to user may be limited by the particular key words that a user inputs as the search text string.

The search engine then consults it's internally stored data describing the various web sites associated with the query and ranks them based upon various factors. The user is then presented with a list of results that might answer their query. The user is then expected to select a result and browse the suggested site for the data they need.

However, there exist a broad range of queries for which a search will not yield the intended answer. For example “What can I do with my kids this weekend?” Traditionally such a searcher has been required to reframe the question into something like “kids activities” and then append a city or state to the query before obtaining meaningful results. Further, the search engine doesn't actually answer the question, rather it provides a list of ranked search results that might answer the user's question following a deeper, and manual analysis by the user.

Moreover, no search engine, no matter how clever in it's use of heuristics, is able to create a set of results without at least some input by the user in the form of a search query. This pre-supposes and requires that the user already knows specifically what they seek and can formulate an adequate query.

### SUMMARY

There is provided a computer-implemented method, executed in a processor, suggesting a locality-related activity at a user interface of a client device enabling a user to discover more about their location. The method comprises accessing a locality platform application at the user interface of the client device, determining a location of the client device, computing at least one influence factor based on the determined location, compiling at least one suggestion for the locality-related activity, the compiled suggestion at least partly based on the at least one influence factor, and providing, at the user interface of the client device, at least one suggestion.

There is also provided a computer system for discovering and suggesting a locality-related activity at a user interface of a client device. The system comprises a locality inference module for determining a location of the client device and a method for computing at least one influencer factor based on the determined location and for compiling at least one suggestion for the locality-related activity, the compiled suggestion at least partly based on at least one influencer factor, wherein the compiled at least one suggestion is provided at the user interface of the client device.

### BRIEF DESCRIPTION OF THE DRAWINGS

The invention will now be described by way of example only with reference to the following drawings in which:

FIG. 1 shows an exemplary embodiment of a communication system architecture for accessing a locality platform having a user interface presented at a client device;

FIG. 2 shows further detail of an exemplary embodiment of a client device architecture as used in the communication system of FIG. 1;

FIG. 3 provides an exemplary method for generating suggested activities at a user interface of the client device;

FIG. 4 provides an exemplary method for determining a location associated with a user of the client device;

FIG. 5 provides an exemplary method of computing the influencers based on the location or locality of the user of the client device;

FIG. 6 provides an exemplary method for compiling suggestions for presentation at the interface of the client device.

FIG. 7 provides an exemplary method for optional consideration of default cravings associated with the user of the client device;

FIG. 8 provides an exemplary method for processing to keywords as used in the exemplary method of FIG. 6;

FIG. 9 provides an exemplary method for picking suggestion patterns as embodied in the exemplary method of FIG. 6;

FIG. 10 provides an exemplary method for filling suggestion patterns as embodied in the exemplary method of FIG. 6;

FIG. 11 provides an exemplary method for generating a next pattern as embodied in the exemplary method of FIG. 10;

FIG. 12 provides an exemplary method for filing a pattern with entities as embodied in the exemplary method of FIG. 10;

FIG. 13 provides an exemplary method for generating a best fit entity as embodied in the exemplary method of FIG. 12;

FIG. 14 provides an exemplary method for plugin process inputs for generating a best entity as embodied in the exemplary method of FIG. 13; and

FIG. 15 provides an exemplary method for scoring entities in order to generate a best entity as embodied in the exemplary method of FIG. 14.

### DETAILED DESCRIPTION

The disclosure herein provides a method and system for autonomously suggesting an activity to a user based on a wide-range of localized factors. The user is not required to manually provide any input to the system prior to receiving benefit from the system. They must simply access the system through one of many different user interfaces (mobile, chat, SMS, web etc). By leveraging automatically inferred properties of the user (such as their geographic location) and cross-referencing them with influencer factors related to that location (for example, time of day, day of week, holiday, status of the sun, weather) the system is configured to provide suggestions to the user regarding what entities or activities they might try or experience, based on a given locality.

By way of examples only, the system might suggest a specific location to eat breakfast in the morning, or a particular theatrical play to see in the evening. It might suggest a walk outside on a sunny and warm day but not if rain or snow were forecast for the user's location in the near future. The system suggests activities that are geographically proximate to the user's location and temporally proximate to the time that the user accesses the system.

Moreover, the system can optionally accept user input if it is provided at any point in the process. This input can take many forms including, but not limited to: a) feedback from the user in the form of “dislike” or “like” the idea. b) text (for example, “I'm bored”, “I'm hungry”, “I want adventure”, “I want to meet people”) providing a vague craving to guide the suggestion engine. c) A future time (for example, “tonight”, “tomorrow”, “next Friday night”) to base the suggestions around. d) a future or alternative location to base the suggestions around. e) all of the above simultaneously. In the case that such user-input is given, it should be noted that the results are still returned in the form of a suggestion for a particular and specific activity, instead of a list of URLs provided in response to a search query.

Lastly, the system will also leverage ratings and reviews data (if available) when considering the fitness of a suggestion prior to returning that suggestion to a user. This data may be in the form of a set of ratings or reviews for a particular business entity, or it might relate to a particular product such as a movie, game or book. In addition the ratings leveraged may also be based on the success of similar suggestions made by the system to prior users who match a specific set of criteria (also known as machine learning).

The end result is that a user accessing the system is given a set of suggestions based on their localized data for activities they might participate in immediately or at a future time and place. The user is not required to exit the system to obtain further data prior to acting on the suggestion, but may do so at their discretion.

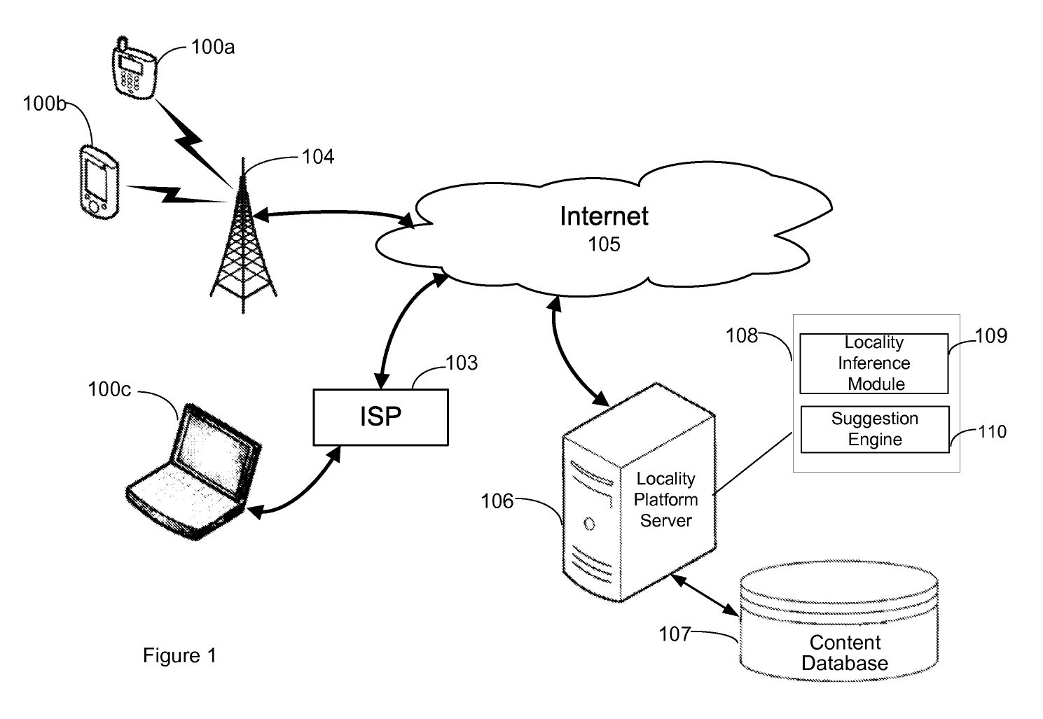

FIG. 1 shows an exemplary embodiment of a communication system architecture for accessing a locality platform via a user interface presented at a client device.

A computing device, or more particularly a client computing device such as a laptop or a desktop computer 100c, mobile phone 100a or Personal Digital Assistant (PDA) 100b (referred to collectively as “client device 100” herein), may be able to connect to the internet 105 over cellular networks via a wireless service provider/carrier system infrastructure 104, for example. Laptop or desktop computer 101 may connect to the internet 105 or other communication network using broadband Internet Service Provider 103, via either a wired landline connection or a wireless connection, for example. The plurality of client devices 100 be loaded with an appropriate browsing application with a user interface for accessing and browsing a locality-based website hosted by locality platform server 106.

Client device 100 may be a two-way communication device having both voice and data communication capabilities, including the capability to communicate with other computer systems.

Locality platform server 106 may be owned and maintained by an Application Service Provider (ASP) which provides a website or web portal application for registered users. The ASP provides access to the locality platform server 106, which is able to determine and deliver relevant content to the client device 100. Locality platform server 106 may have access to one (or more) content database(s) 107.

Locality platform server 106 may comprise a plurality of different components including a computer processor, and a locality suggestion module 108. It should also be appreciated that the computer processor is able to execute computer program instructions for carrying out all of the functions of the locality suggestion module 108 described herein, including locality inference module 109 and suggestion engine 110.

Locality inference module 109 may comprise any combination of software, firmware and hardware to infer a locality or community of a requestor client device, based on determining a location of client device 100. For instance, for a given location in a large, populous city, there may exist multiple neighborhood or local communities (or localities) within even a single segment of such a city. On the other hand, for sparsely populated regions or states, a “locality” may be considered to encompass hundreds of square miles, even across geopolitical state boundaries. Locality inference module 109 may also serve the function of accessing the multitudinous designations of communities, keeping track of locality names, boundaries and other community designations capable of being associated with physical locations.

Suggestion Engine 110 may comprise any combination of software, firmware and hardware to compile and generate the suggestions based on location or locality influencers or attributes, and deciding the best suggestions to be provided to the user via the locality platform interface 240 of client device 100.

Alternate arrangements where locality inference module 109 is resident at client device 100 instead of within locality platform server 106 are also contemplated.

Furthermore, aspects of the disclosure as illustrated in FIG. 1 may be implemented via computer software in the form of computer readable code executed in memory by processors on one or more of the computers or servers contemplated above. Although the present FIG. 1 illustrates separate components, it is contemplated, and should be understood, that various components could be combined into a single computer or server, or implemented across multiple computers or servers all connected via a communications medium (such as the Internet) without departing from the scope of the present invention.

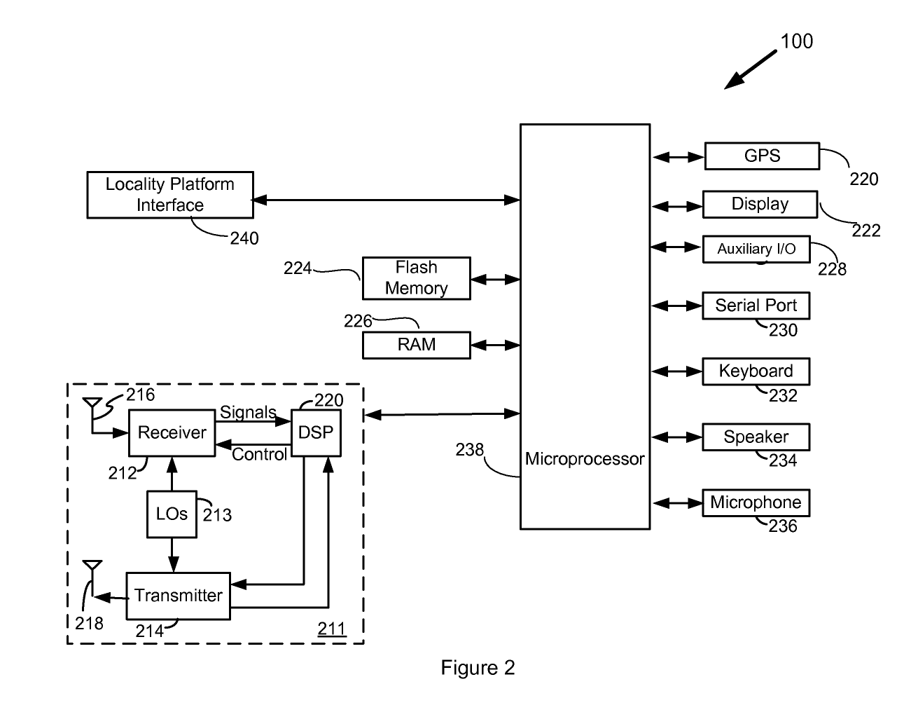

FIG. 2 shows further detail of client device 100 configured according to an exemplary embodiment. Client device 100 may include a communication subsystem 211 which includes a receiver 212, a transmitter 214, and associated components, such as a processing module such as a digital signal processor (DSP) 220. As will be apparent to those skilled in field of communications, the particular design of the communication subsystem 211 depends on the communication network in which client device 100 is intended to operate.

Client device 100 includes a microprocessor 238 which controls general operation of the device. The microprocessor also interacts with additional device subsystems such as a display 222, a flash memory 224, a random access memory (RAM) 226, a keyboard 232, a speaker 234, a microphone 236, a short-range communications subsystem such as BLUETOOTH (Blueooth™) for example, and any other device subsystems or peripheral devices. Client device 100 may also include a positioning device, such as a GPS receiver 220 for example. The GPS receiver 220 may be configured to detect and provide location information in order to determine the location of the client device 100. In the case of a non-location-aware desktop computer, its uniquely-assigned Internet Protocol (IP) address may be associated with a unique location of that desktop computer client device 100.

Operating system software used by the microprocessor 238 of client device 100 may be stored in a persistent store such as the flash memory 224, which may alternatively be a read-only memory (ROM) or similar storage element for storing computer program instructions thereon. The microprocessor 238, in addition to its operating system functions, may enable execution of software applications on the client device 100. A predetermined set of applications may be installed on the client device 100 during its manufacture. These may typically include data and voice communication applications, for example. The screen display 222 of client device 100 may be used to visually present an application's graphical user interface (GUI) to the user. The user can manipulate application data by modifying information on the GUI using an input device such as a keyboard 232 or other types of input devices, for example, a scroll wheel, trackball, light pen or touch sensitive screen.

Locality platform user interface 240 is shown in FIG. 2 installed and operative on client device 100 according to an alternate exemplary embodiment.

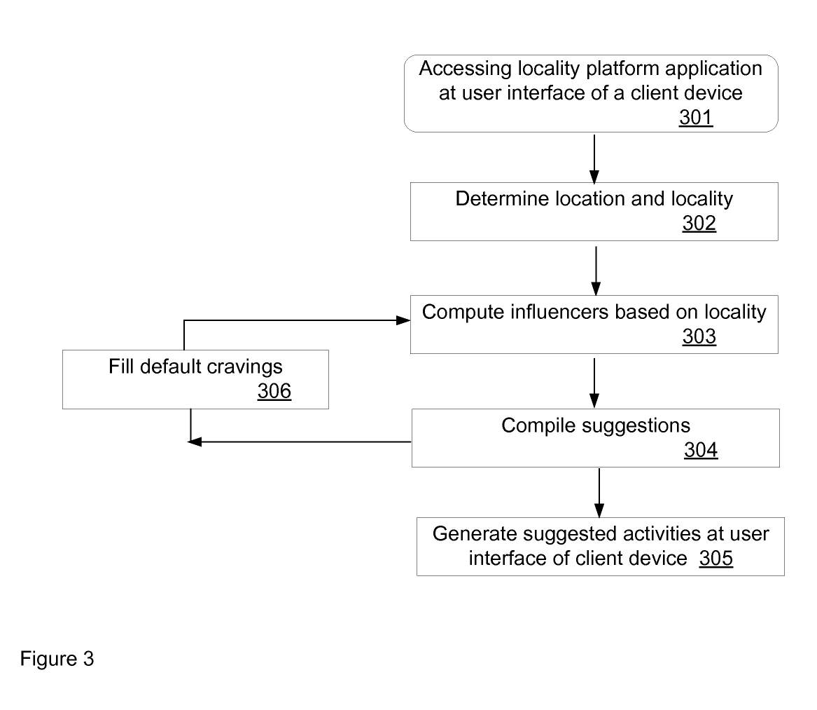

FIG. 3 provides an exemplary method for generating suggestions at locality platform interface 240 of the client device 100. As used herein, the term “suggestion” means a recommendation, based on the user's cravings as well as external conditions, about what the user can see or do proximate a certain location. For example, “Go to Kelsey's Restaurant and then see Planet 51 at 7:30 pm”. The details of the suggestion, once assented to or adopted by the user, may be made available in the user's Itinerary or Calendar applications, and include (in this case) the address of a specific location of Kelsey's as well as phone numbers and hours of operation (if available) as well as the theatre where the movie is playing at the specific 7:30 pm time.

Still with regard to terminology, a “craving” as used herein is an example of an influencer, and comprises plain text input from the user describing what they are interested in seeing or doing at this moment in time. Examples: “I am bored and hungry”, “I feel adventurous” or “I want to be a tourist”. A craving is typically vague because the user doesn't already know what they want. However, it may also be more specific like “I want to get pizza and see a movie”.

Also as used herein, the term “suggestion pattern” refers to a “fill in the blanks” text string that represents one possible idea for a user, but is devoid of actual local content prior to being filled. For example, “Go for a romantic walk at [PUBLIC PARK] then get a treat at [CAFE or DONUT SHOP].” Suggestion engine 110 serves to fill in the blanks with a local content or local entity for the suggestion pattern, thus creating the suggestion which is then provided to the locality platform user interface 240 of client device 100. A blank thus lacks the actual locality content, and consists only of meta data describing the criteria against which potential entities are compared.

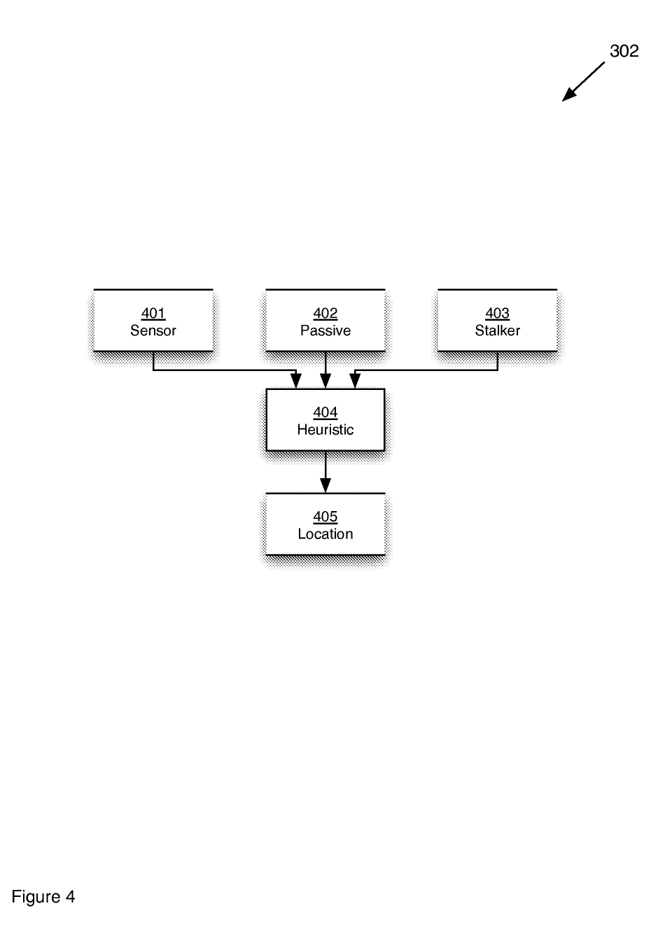

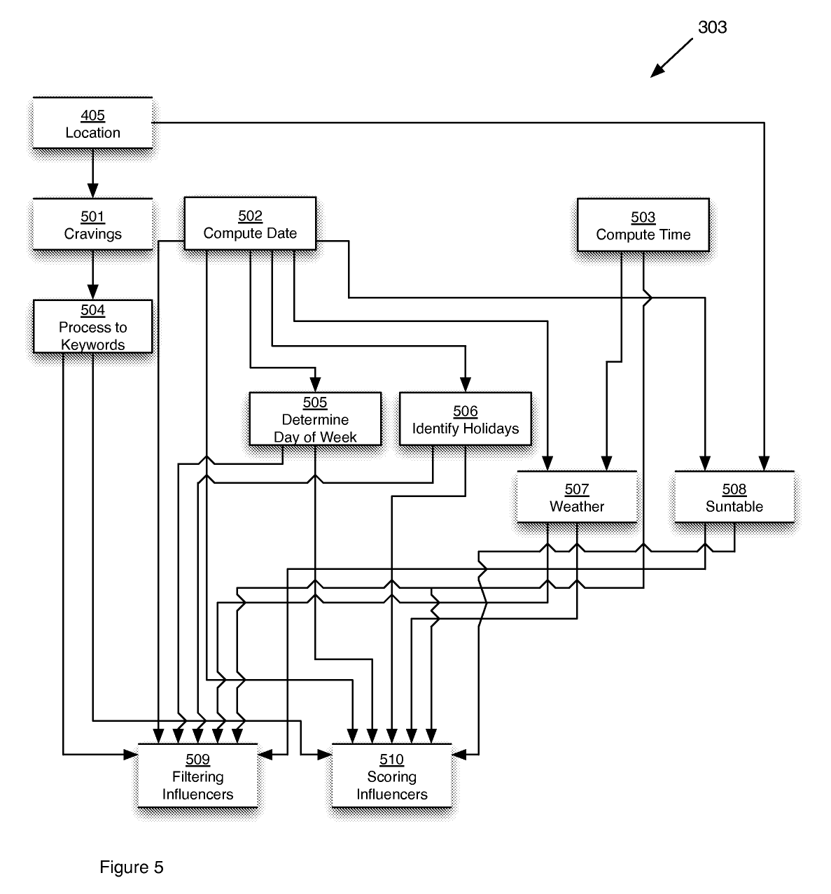

Still with reference to FIG. 3, at step 301, the user of client device 100 accesses the locality platform interface 240. At step 302, the location, and also a locality, of the user at client device 100 is determined. Locality inference module 109 determines the user's location with a heuristic that weights and prioritizes a variety of possible inputs. FIG. 4 discussed below provides more details of the location and locality determination. At step 303, suggestion engine 110, by combining user input (cravings and location) and system data, computes a set of influencers, which is a collection of data that represents known information about the user and also the conditions existing in their locality. FIG. 5 discussed below provides more details of the computation process. As used herein, the term influencer refers to criteria used to filter and score suggestion patterns and local content. Such criteria can be provided by the user, as in the case of cravings and location, or can be determined by system as in the case of time, weather, etc. For example, an influencer of “morning” would exclude suggestion patterns relating to dinner. An influencer of “wet and cold” would cause a suggestion pattern involving long periods outdoors to be relatively disregarded.

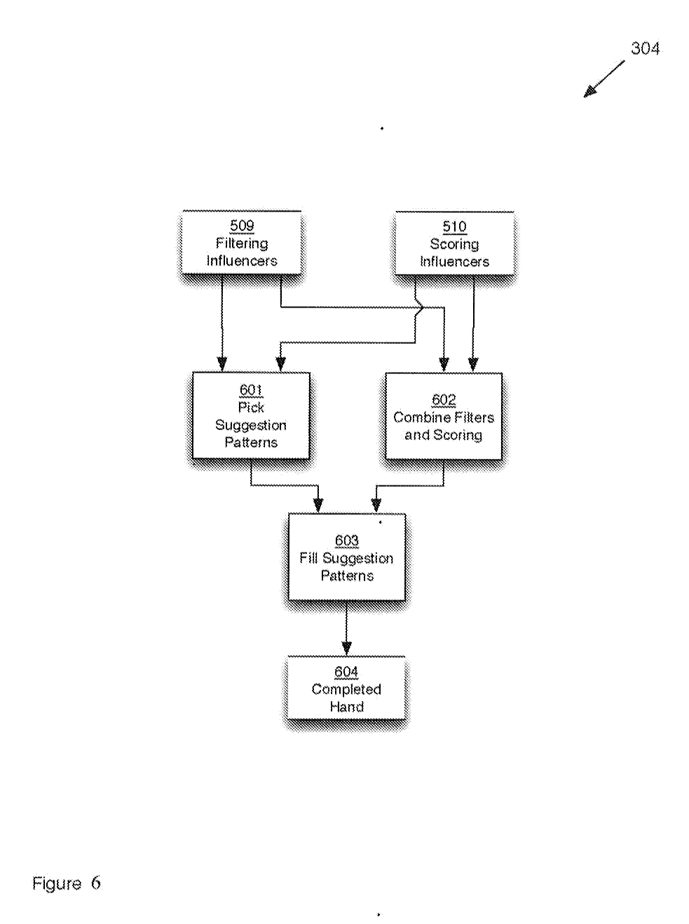

At step 304, leveraging the computed influencers and the determined location, suggestion engine 110 filters and scores its available suggestion patterns, then populates the patterns with the best entities. At step 305, the compiled suggestions comprising the best entities are provided to the user of client device 100 via locality platform user interface 240. More details of the filtering, scoring, and compilation process are discussed in regard to FIG. 6 below.

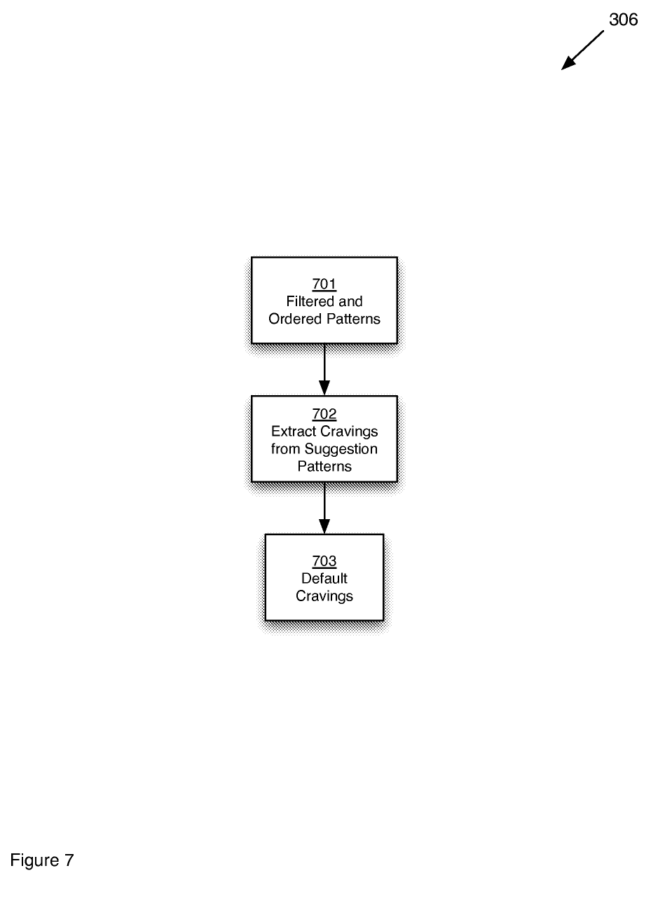

Optionally, step 306 may be performed. In the case where the user has not provided any input cravings, suggestion engine 110 determines a set of suggestion patterns that meet every other known need and feeds the best craving from that set back into step 303, repeating the process again. More details of the process to fill the default cravings are discussed below with reference to FIG. 7.

Now with reference to FIG. 4 and techniques for location determination used in locality inference module 109, at step 401, a sensor detects and uses any or all installed browser-based location sensors, including but not limited to Skyhook Wireless' Loki, W3C's GeoLocation API, Google's Gears GeoLocation API or direct IP Address lookups. On Mobile devices where GPS, WiFi Triangulation or Cell-tower triangulation are available these may also form part of the sensor data package.

Step 402 is based on passive data such as string-based information. Usually inexact and entered by a user in response to a “where are you?” prompt. The string needs to be parsed and analyzed to determine type of data (e.g. partial or full address, phone number, neighborhood name, street intersection, major or minor landmark, etc.) and then compared against the appropriate database or third-party geo-location service to determine a latitude and longitude approximation.

Step 403 is based on stalker data, location data the system has inferred or created based on a user's activity. This includes the location of system entities that the user has browsed and is interested in (e.g. a store's location), specific user settings gathered from past activity or explicit profile data (incl. third party profiles), or even text entered by the user in the “wrong place” (like the Craving input).

At step 404, all inputs from steps 401, 402 and 403 may be compared and cross-checked. Statistical outliers may be discarded and a determination as to which input(s) to use is made. Passive data entered by the user may take priority if an exact match can be made, otherwise sensor data may be used to narrow the possible matches to the user's input to provide a single location. Stalker data may be used primarily when no sensor or user input data is available, or as a means to corroborate the determination of location made based on Sensor and Passive data. At step 405, the user's location information determined includes details such as address specifics (street, city, state, etc), latitude and longitude, and locality or neighborhood.

FIG. 5 provides an exemplary method of computing the influencers based on the location or locality of the user of the client device. At step 501, plain text information about what needs the system should try to fill may be submitted as part of the request, typically entered by the user. e.g. “I am bored and hungry”, “I want family fun”, “We want to go shopping”. At step 502, the current date at the user's location is determined. The date may optionally be a user-specified date in the future. At step 503, the current time at the user's location is computed. The user may optionally specify a time in the future as part of the request. At step 504, the text of the craving is analyzed and converted into a format usable by the system for both filtering at step 509 and scoring at step 510. At step 505, based on the date, the appropriate day of the week is determined and converted into a format usable by the system for both filtering at step 509 and scoring at step 510. At step 506, any holidays that occur on the current (or requested) date at the current location are identified and converted into a format usable by the system for both filtering at step 509 and scoring at step 510. At step 507, using any available weather service or data, the current or forecasted conditions for the date and time are converted into a format usable by the system for both filtering at step 509 and scoring at step 510. At step 508, the sunrise and sunset times are calculated using standard formulas based on date and location and converted into a format usable by the system for both filtering at step 509 and scoring at step 510. At step 509, a set of data representing criteria must exist for a suggestion pattern to be considered eligible for the final set of suggestions as returned to the user. At step 510, a set of data representing criteria is used to calculate fitness of suggestion patterns via scoring, once it is deemed eligible. (box 401).

FIG. 6 provides an exemplary method for compiling suggestions for presentation at the interface of the client device. At step 601, from the pool of all suggestion patterns, several rounds of filtering of the influencer data from step 509 are done. Eligible patterns are then scored and ranked for precision when matching the user's desires as well as the prevailing local conditions. At step 602, the filtering influencers and scoring influencers are combined into a single pool of entity scoring influencers. Any potential duplicates may be purged. At step 603, potential entities (businesses, events and other data) are analyzed and ranked. Where possible, each pattern is filled resulting in a card. If a pattern cannot be completely filled, it is discarded. As used herein, a “card” is a single filled suggestion pattern that the user may elect to follow (for example, by viewing the Itinerary) or discard (by looking at another card or hand). With further regard to terminology used herein, a deck refers to the large set of filled suggestion patterns that satisfy the influencers of a specific request. A hand refers to a subset of the deck, comprising, for example, 5 cards, as presented initially to the user via the user interface. At step 604, a completed hand comprising a full set of filled patterns is obtained.

FIG. 7 provides an exemplary method for optional consideration of default cravings associated with the user of the client device. At step 701, from the set of filtered and ordered patterns, the default cravings associated with each pattern may be extracted, at step 702, and compiled into a list of cravings. At step 703, these cravings comprise the default cravings to use in the case where no user-entered cravings were submitted.

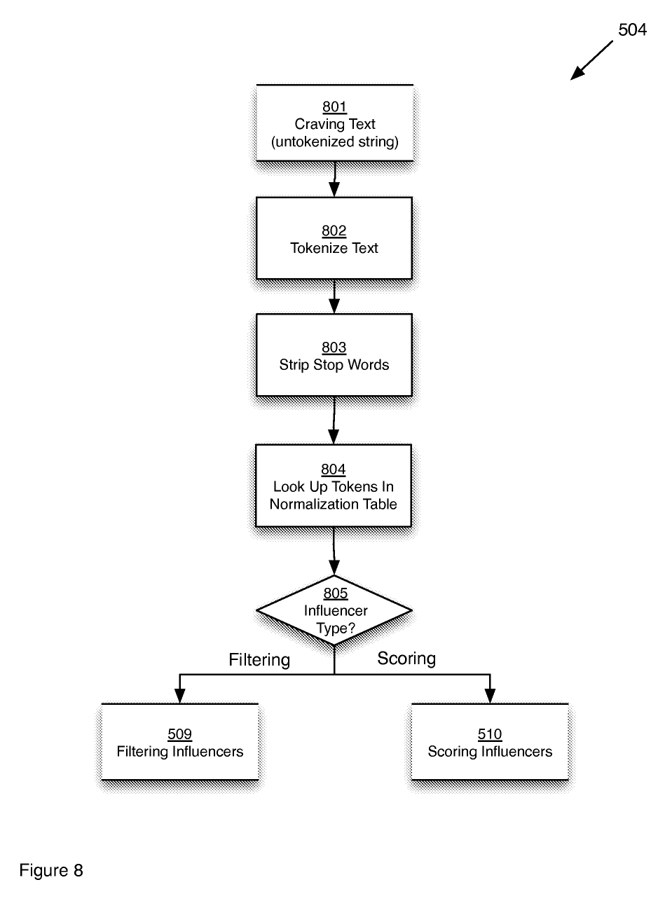

FIG. 8 provides an exemplary method for processing to keywords as used in the exemplary method of FIG. 6. At step 801, the craving text comprising an un-tokenized string is entered by the user. At step 802, the text is parsed into tokens comprised of one or more words from the craving text. At step 803, common words that carry no meeting (“I”, “and”, etc) are removed from the collection of tokens. At step 804, tokens are looked up in a normalization table. To allow the system to understand a wide range of cravings, the lookup table used may be comprised of the most common words in the English language and a comparatively small set of influencers that are used either for filtering or for scoring. The tokenized craving text is compared against the known common words and converted and added to the sets of filtering influencers or scoring influencers. At step 805, the type of influencer, either filtering or scoring, is determined and the influencer may be added to the appropriate set for use in later analysis.

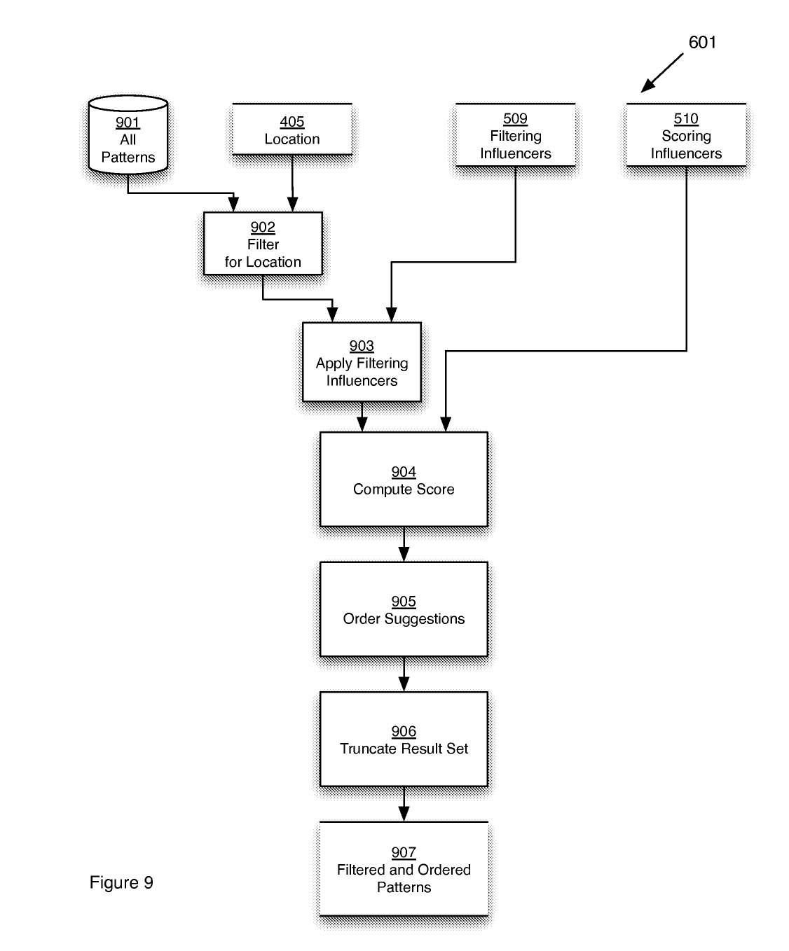

FIG. 9 provides an exemplary method for picking suggestion patterns as embodied in the exemplary method of FIG. 6. At step 901, each suggestion pattern from the database has a set of required and optional properties as well as one or more blanks. The entire set may be used in the filter process. At step 902, the patterns that are eligible are in part determined by the level of accuracy of the location determination at step 405. There may be four levels of accuracy, for example, and each suggestion pattern has an accuracy property that must match the location's accuracy. This allows making very specific suggestions when a high level of accuracy exists and to suggest more general activities when it does not. At step 903, only those suggestion patterns that match the criteria specified in the set of filtering influencers may be eligible for inclusion, and the rest may be discarded. At step 904, each eligible Suggestion Pattern is compared against the scoring influencers. For each match the pattern's score is (proportionally) increased, allowing the best patterns to have the highest scores. At step 905, higher scored suggestion patterns are moved to the top of the list. Where multiple suggestion patterns exist with the same score (ties), ordering may be randomized. At step 906, the process may often result in a very large number of patterns. To minimize work involved when filling the patterns later (see step 1003), the final set of patterns may be truncated appropriately. At step 907, a truncated set of eligible suggestion patterns is obtained, ordered from highest score to lowest score.

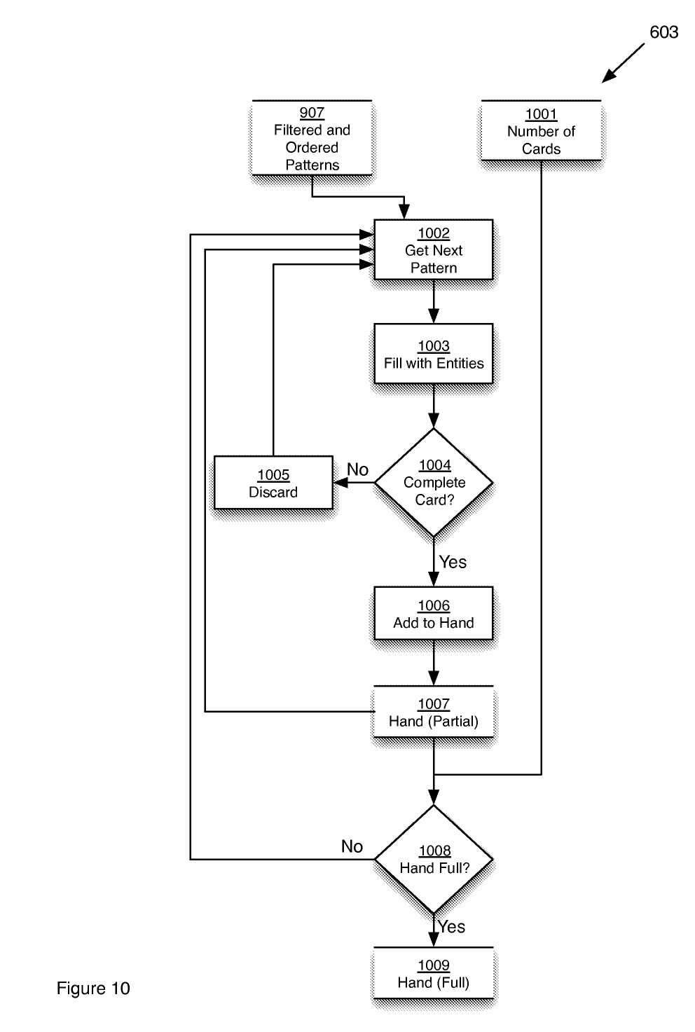

FIG. 10 provides an exemplary method for filling suggestion patterns as embodied in the exemplary method of FIG. 6. At step 1001, a number of cards per hand is set, representing a system property that defines the number of filled cards required in a set to be considered a full hand. At step 1002, the next suggestion pattern to be filled is selected. At step 1003, the current suggestion pattern is filled with entities. At step 1004, if an incomplete card is the result at step 1003, the card is discarded and flow returns to step 1002 “Get Next Pattern”, otherwise flow continues to step 1006 “Add to Hand”. At step 1005, an incomplete card is discarded. At step 1006, a complete card is added to the hand. At step 1007, with regard to partial hands, a storage container is provided for the collection of complete cards. At step 1008, if the number of cards in the set matches the system property, then the hand is determined to be full.

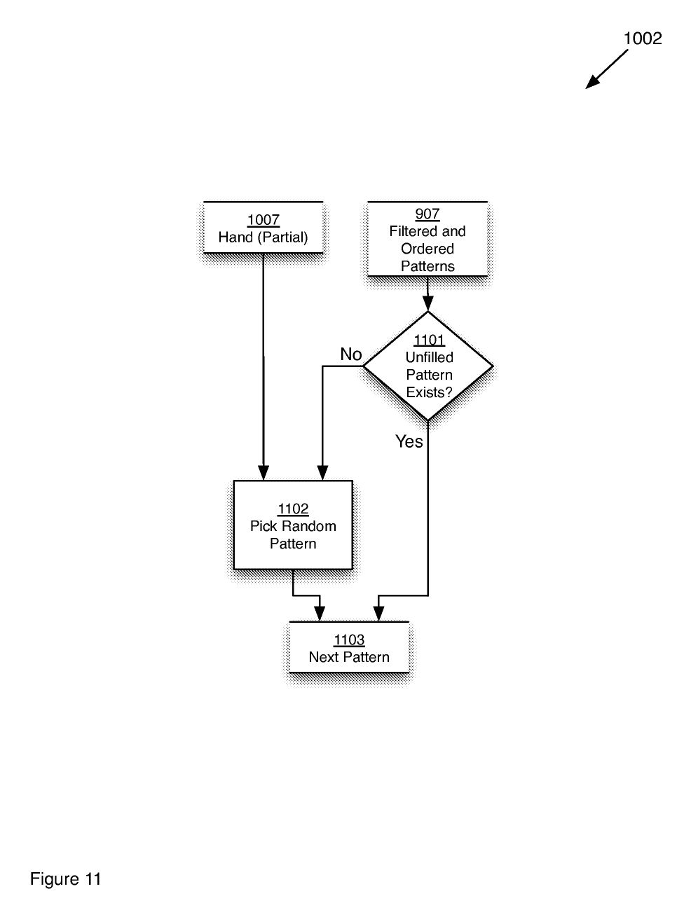

FIG. 11 provides an exemplary method for generating a next pattern as embodied in the exemplary method of FIG. 10. At step 1101, it is determined whether an unfilled pattern exists, that is, from the set of filtered and ordered patterns of step 907, is there one that has not been filled? At step 1102, if no eligible suggestion exist that have not been filled and cards are needed, any of the patterns used by cards in the hand may be picked to fill again. At step 1103, either an unfilled suggestion pattern or a previously filled pattern is selected.

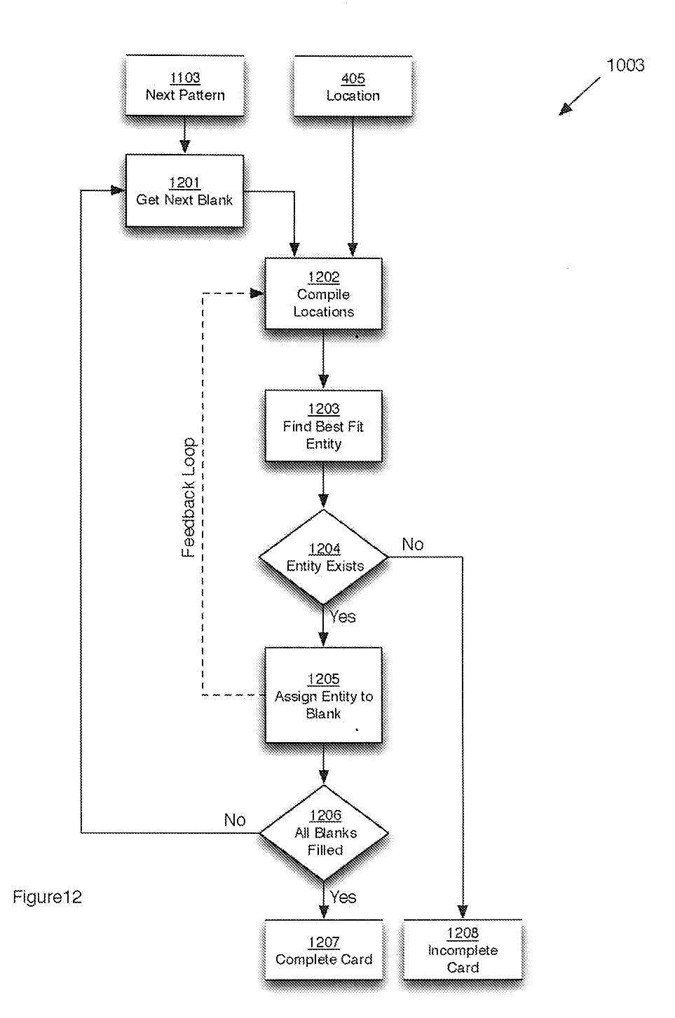

FIG. 12 provides an exemplary method for filing a pattern with entities as embodied in the exemplary method of FIG. 10. At step 1201, from the current pattern (see step 1103), the next unfilled blank is selected. At step 1202, locations are compiled. As each blank is filled the list of locations is compiled. For the first blank, only the user's location (see step 405) is available. As blanks are filled, the location of the entity used to fill the blank(s) are added to the list. At step 1203, the best fit entity is determined. The best fit entity is that which best satisfies the criteria of this blank. Best fit may be determined based on a variety of criteria, including the blank's meta data, influencers, the list of already used locations, popularity and more. At step 1204, if no matching entity exists and the Blank cannot be filled, processing stops and an incomplete card is returned. At step 1205, if an entity is found, it is assigned to the blank and its location is added to the list of compiled locations for this card. At step, 1206, if it is determined that all blanks are filled, and there are no unfilled blanks, the card is complete and returned as a completed card at step 1207, or at step 1208 as an incomplete card whose blanks could not be filled.

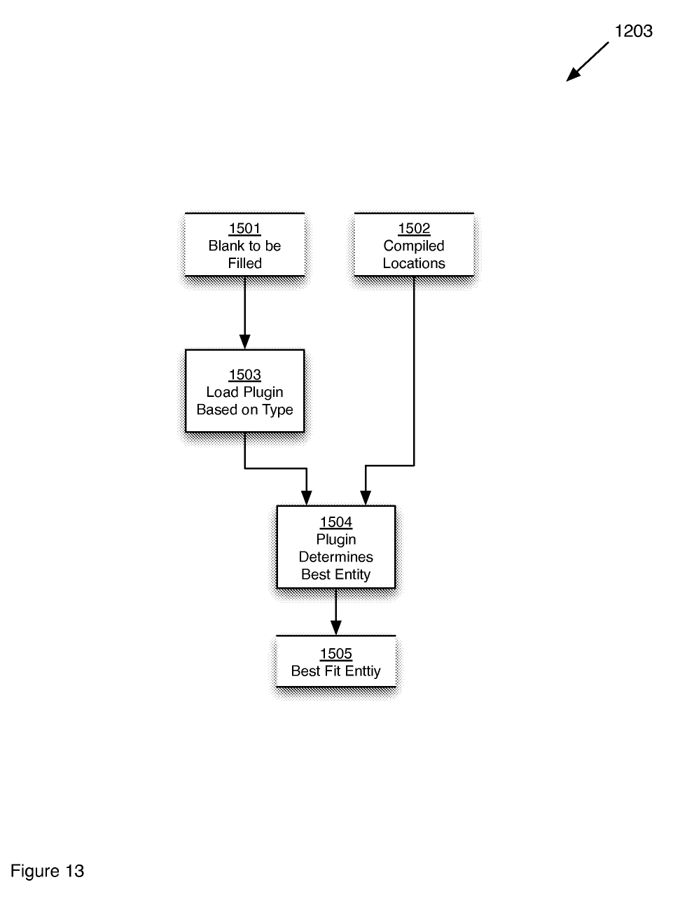

FIG. 13 provides an exemplary method for generating a best fit entity as embodied in the exemplary method of FIG. 12. At step 1301, a blank to be filled, and it's associated meta-data, is identified and from the pattern definition (see step 1201). At step 1302, the list of compiled locations is considered when filling this blank (see step 1202). Consideration heuristics may handled by a plugin infrastructure (see step 1304 below). At step 1303, depending on what type of blank is to be filled (type being specified as part of the meta-data), a specific plugin will be loaded. At step 1304, the plugin determines the best entity. Each plugin to determine entity fitness implements a common interface, but in the specifics may be slightly different. At step 1305, the best entity for this blank is returned.

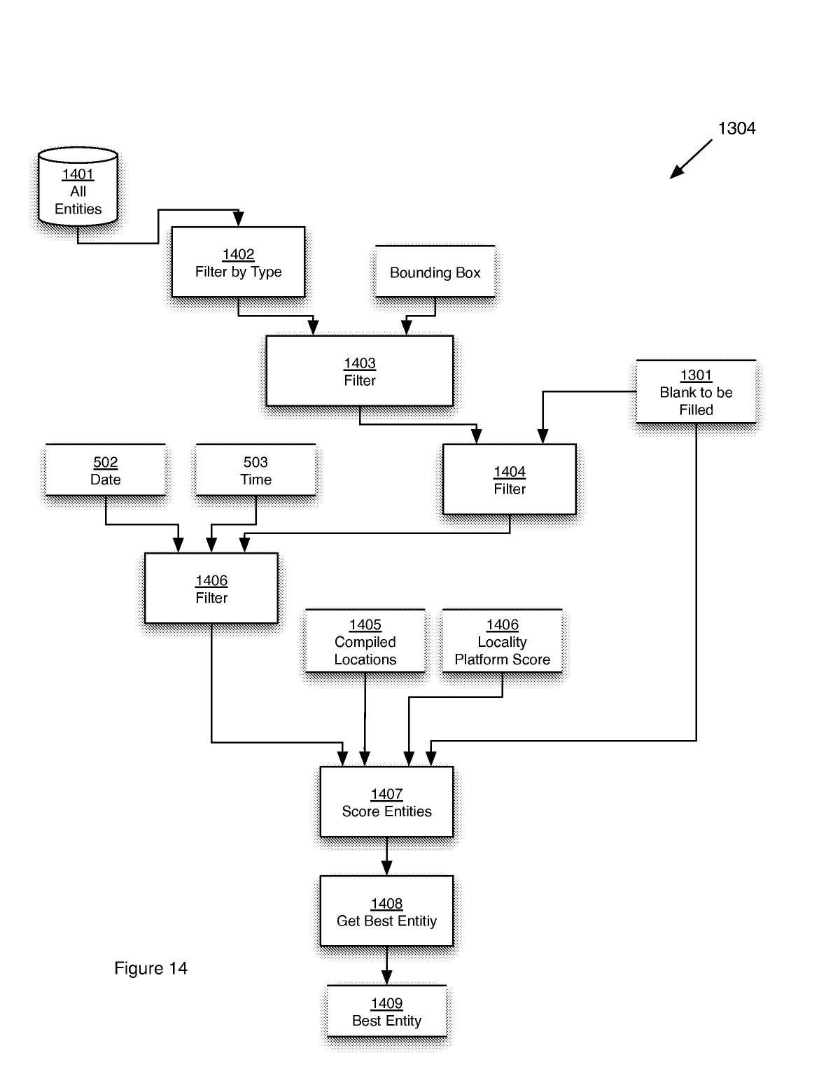

FIG. 14 provides an exemplary method for plugin process inputs for generating a best entity as embodied in the exemplary method of FIG. 13. At step 1401, all entities in system are listed and identified. At step 1402, filtering is applied, by entity type. Only entities that match the type defined by the blank are eligible. At step 1403, filtering by a “bounding box” is performed. Only entities within a specific geographic region may be considered eligible, for example. The bounding box may be a runtime property related to the user's location, for example, “25 miles”, which implies entities are only eligible if they are within the box defined by drawing a box around a circle that is 25 km in radius. This box may vary based on entity type and population density or data density. At step 1404, filtering by the blank's filters are performed, for instance, only entities whose properties match the required criteria specified by the blank. At step 1405, filtering by date and time is performed. For some blank types, only entities occurring within a specific window of time are eligible. At step 1406, a system score is determined, the score being, for example, an integer value from 1 (lowest)-10 (highest) calculated when data is added to the system. Each entity in the system is given a score. This score is a form of aggregate based on the reviews and ratings on partner and third party sources. As well as direct ratings may be provided to the system. At step 1407, entities are scored by weighting proximity to the compiled locations (see step 1205), system score (see step 1406) and the scoring criteria set for the blank (see step 1301). At step 1408, the entity with the highest score in retrieved, and at step 1409 is determined to be the best entity.

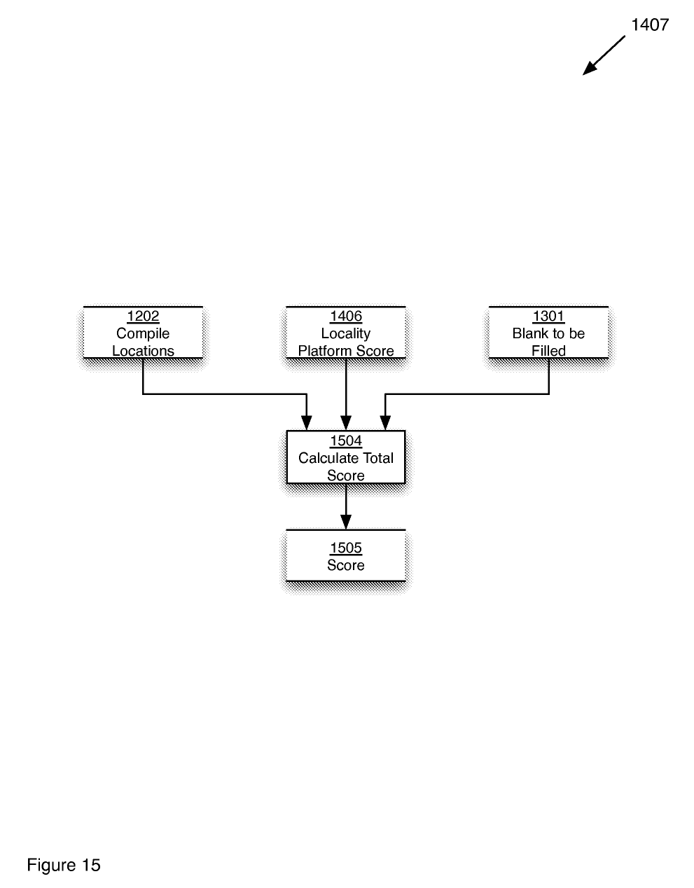

FIG. 15 provides an exemplary method for scoring entities in order to generate a best entity as embodied in the exemplary method of FIG. 14. At step 1501, the total score is computed. Entities are scored by weighting proximity to the compiled locations (see step 1205), system score (see step 1406) and the scoring criteria set on the blank (see step 1301). At step 1502, a score comprises an integer from 1 (worst) to 10 (highest) representing the quality of the entity in relation to public opinion, context, user reviews and proximity to the other entities already in the card.

Although preferred embodiments of the invention have been described herein, it will be understood by those skilled in the art that variations and combinations thereof may be made thereto without departing from the scope of the appended claims. In yet further instances, it is contemplated that the methods performed and described herein may be performed in different orders or sequences than the exemplary embodiments presented herein.

What is claimed is:

1. A computer-implemented method, executed in a processor, of discovering and suggesting a locality-related activity at a user interface of a client device, the method comprising:
accessing a locality platform application at the user interface of the client device;
determining a location of the client device;
computing at least one influencer factor based on the determined location;
compiling at least one suggestion for the locality-related activity, the compiled suggestion at least partly based on the at least one influencer factor;
and
providing, at the user interface of the client device, the at least one suggestion.

2. The method of claim 1 further comprising inferring a locality from the determined location, and computing at a least a second influencer factor based on the inferred locality.

3. The method of claim 2 further comprising compiling the at least one suggestion at least partly based on the at least a one influencer and the at least a second influencer factors.

4. The method of claim 1 wherein the location of the client device is determined based on use of an installed browser-based location sensor.

5. The method of claim 1 wherein the location of the client device is determined as an approximate latitude and longitude, the determination being based on parsing passive data entered by a user in response to a prompt, the passive data comprising a text string.

6. The method of claim 1 wherein the location of the client device is inferred as the location of an entity associated with a prior activity at the user interface of the client device.

7. The method of claim 1 wherein the step of accessing a locality platform application comprises access using a user interface selected from the group of user interfaces consisting of mobile, chat, SMS, and a web-based user interface.

8. The method of claim 1 further comprising selecting, at the user interface of the client device, the at least one suggestion provided, and in response to the selecting, storing within a memory of the client device, a location, a time and a phone number of the suggested locality-based activity.

9. The method of claim 1 further comprising compiling the at least one suggestion for the locality-related activity at least partly based on review and rating data.

10. A computer system for discovering and suggesting a locality-related activity at a user interface of a client device, the system comprising:
a locality inference module for determining a location of the client device; and
a suggestion engine for computing at least one influencer factor based on the determined location and for compiling at least one suggestion for the locality-related activity, the compiled suggestion at least partly based on the at least one influencer factor;
wherein the compiled at least one suggestion is provided at the user interface of the client device.

11. The computer system of claim 10 wherein the locality inference module infers a locality from the determined location, and the suggestion engine computes at a least a second influencer factor based on the inferred locality.

12. The computer system of claim 11 wherein the suggestion engine compiles the at least one suggestion at least partly based on the at least one influencer and the at least a second influencer factors.

13. The computer system of claim 10 wherein the location inference module determines the location of the client device based on use of an installed browser-based location sensor.

14. The computer system of claim 10 wherein the location inference module determines the location of the client device based on parsing passive data entered at the user interface of the client device in response to a prompt, the passive data comprising a text string.

15. The computer system of claim 10 wherein the location inference module determines the location of the client device by inferring the location of an entity associated with a prior activity at the user interface of the client device.

16. The computer system of claim 10 wherein the at least one suggestion is provided via a user interface selected from the group of user interfaces consisting of mobile, chat, SMS, and a web-based user interface.

17. The computer system of claim 10 further comprising selecting, at the user interface of the client device, the at least one suggestion provided, and in response to the selecting, storing within a memory of the client device, a location, a time and a phone number of the suggested locality-based activity.

18. A client device for receiving and displaying a suggestion of a locality-based activity, the client device comprising:
a user interface application for accessing a locality platform; and
a locality inference module for determining a location of the client device;
wherein at least one suggestion of a locality-related activity is received from the locality platform, the at least one suggestion for provision at the user interface of the client device at least partly based on the determined location.

19. A communication system for autonomously suggesting a locality-related activity when a locality platform application is accessed at a user interface of a client device, the communication system having a processor and memory, the memory including instructions stored thereon, which, when executed by the processor, cause the communication system to perform the steps of:
determining a location of the client device;
computing at least one influencer factor based on the determined location;
compiling at least one suggestion for the locality-related activity, the compiled suggestion at least partly based on the at least one influencer factor; and
providing, at the user interface of the client device, the at least one suggestion.
